(19) United States
(12) Patent Application Publication
(10) Pub. No.: US 2026/0342599 A1
(43) Pub. Date: Oct. 29, 2026

(54) SLIDING-WINDOW BASED ORDER RELAXATION FOR ENCRYPTED CHANNEL

(71) Applicant: Hewlett Packard Enterprise Development LP, Spring, TX (US)

(72) Inventors: Derek Alan Sherlock, Ft. Collins, CO (US); Frank R. Dropps, Annandale, MN (US); Keith D. Underwood, Powell, TN (US)

(21) Appl. No.: 19/291,295

(22) Filed: Aug. 5, 2025

Related U.S. Application Data
(60) Provisional application No. 63/795,769, filed on Apr. 28, 2025.

(51) Int. Cl. H04L 9/34

(52) U.S. Cl. CPC H04L 9/34

(57) ABSTRACT

A requester generates a full initial value (IV) associated with encryption of roundtrip communications with a responder. The requester sends, to the responder, a request indicating a security value comprising a number of least significant bits (LSBs) of the full IV. The LSBs identify an epoch associated with a predetermined number of requests allowed to be sent, either in order or out of order, by the requester to the responder. The requester identifies a sliding window associated with: active epochs corresponding to a time window in which the predetermined number of requests are currently allowed to be sent; and at least one inactive epoch corresponding to a time window in which the predetermined number of requests are currently not allowed to be sent. The requester advances the sliding window by setting an oldest active epoch to an inactive epoch and by setting a currently inactive epoch to an active epoch.

### RELATED APPLICATION

This application claims the benefit of U.S. Provisional Patent Application No. 63/795,769, Attorney Docket Number P177460USPRV, entitled “SLIDING-WINDOW BASED ORDER RELAXATION FOR ENCRYPTED CHANNEL,” by Derek Alan Sherlock, Frank R. Dropps, and Keith D. Underwood, filed on 28 Apr. 2025.

### BACKGROUND

Some developing network fabric specifications use an encryption protocol that requires in-order delivery of messages. For example, the AES-GCM-256 protocol uses a shared key and a unique initial value (IV) for encrypted operations between a requester and a responder. While the key may be used repeatedly, reusing the IV with the same key may weaken security by creating a vulnerability to cryptographic attack. The IV may be generated by the requester and transmitted in plaintext, i.e., full-length IV transmission. The IV may also be maintained by both the requester and the responder, e.g., based on a synchronized counter which requires in-order message delivery.

### BRIEF DESCRIPTION OF THE FIGURES

FIG. 1 illustrates an environment which facilitates sliding-window based order relaxation for an encrypted channel, in accordance with an aspect of the present application.

FIG. 2A illustrates a bit-field chart depicting a full IV maintained by a requester, in accordance with an aspect of the present application.

FIG. 2B illustrates a bit-field chart depicting a partial IV maintained by a responder, in accordance with an aspect of the present application.

FIG. 2C illustrates a diagram of hardware or data structures maintained by a requester, in accordance with an aspect of the present application.

FIG. 2D illustrates a diagram of hardware or data structures maintained by a responder, in accordance with an aspect of the present application.

FIG. 2E presents a flowchart illustrating operations by a requester in sending requests, in accordance with an aspect of the present application.

FIG. 2F presents a flowchart illustrating operations by a requester in receiving a response, in accordance with an aspect of the present application.

FIG. 2G presents a flowchart illustrating operations by a responder in receiving a request, in accordance with an aspect of the present application.

FIG. 2H presents a flowchart illustrating operations by a responder in sending a response, in accordance with an aspect of the present application.

FIG. 3A illustrates a diagram of the operations of a requester in sending requests and receiving responses based on a multi-epoch sliding window, in accordance with an aspect of the present application.

FIG. 3B illustrates a diagram of the operations of a responder in receiving requests and sending responses based on a multi-epoch sliding window, in accordance with an aspect of the present application.

FIG. 3C illustrates a diagram depicting four states of the responder, based on the exemplary four epochs in the multi-epoch sliding window of FIG. 3B, in accordance with an aspect of the present application.

FIG. 4 illustrates a diagram of how initial values (IVs) are generated, derived, and incremented by a responder and a requester, in accordance with an aspect of the present application.

FIG. 5 illustrates a diagram of the operations of a responder based on a multi-epoch sliding window with three active epochs and one inactive epoch, including identification of which partial IV is used by the responder in reconstructing the full IV, in accordance with an aspect of the present application.

FIG. 6A presents a flowchart illustrating a method which facilitates sliding-window based order relaxation for an encrypted channel, including operations by a requester, in accordance with an aspect of the present application.

FIG. 6B presents a flowchart illustrating a method which facilitates sliding-window based order relaxation for an encrypted channel, including operations by a responder, in accordance with an aspect of the present application.

FIG. 7 illustrates a computing system which facilitates sliding-window based order relaxation for an encrypted channel, in accordance with an aspect of the present application.

FIG. 8 illustrates a computer-readable medium which facilitates sliding-window based order relaxation for an encrypted channel, in accordance with an aspect of the present application.

In the figures, like reference numerals refer to the same figure elements.

### DETAILED DESCRIPTION

Aspects of the present application provide a system which facilitates sliding-window based order relaxation for an encrypted channel.

As described above, some developing network fabric specifications use an encryption protocol that requires in-order delivery of messages. For example, the AES-GCM-256 protocol uses a shared key and a unique initial value (IV) for each encryption operation between a requester and a responder. While the key may be used repeatedly, reusing the IV with the same key may weaken security by creating a vulnerability to cryptographic attack. Current solutions exist to ensure that the requester and responder use the same key and IV value for encryption and decryption of a single message (e.g., request or response) sent between the requester and responder. In one solution, the requester may generate and transmit the IV in plaintext to the responder, resulting in full-length IV transmission. However, the transmission of full-length IV values with every message may incur significant bandwidth overhead. In another solution, the IV may be maintained by both the requester and the responder as a synchronized counter. With synchronized counters, in-order message delivery is needed to ensure that the IV counters maintained by the requester and the responder remain in sync. However, in-order delivery may consume extra network resources or unacceptably constrain the use of multiple parallel network paths, especially in large-scale high-performance computing (HPC) networks.

The described aspects provide a system which relaxes these in-order delivery constraints while maintaining a secure, encrypted channel for roundtrip communications between a requester and a responder over a network fabric that does not require the transmission of full-length IV values. The requester and responder continue to use a shared key and a common IV for encrypted communication. However, instead of sending the full IV with each request, the requester transmits a request with only a subset of the full IV, such as a number of the least significant bits (LSBs) (referred to as “IV-LSB”), while the responder reconstructs the full IV by combining the received IV-LSB with its own counter which tracks the remaining most significant bits (MSBs) (referred to as “IV-MSB”). This approach reduces bandwidth overhead by transmitting less IV data while allowing for out-of-order message delivery. The responder may encrypt its response using the shared key and reconstructed IV, without transmitting any IV bits back, which allows the requester and responder to use almost the same IV for encryption/decryption and ensure that their respective counters remain in sync while only the requester transmits only a portion of the full IV. Because an IV value should never be repeated for the same encryption key, the IV value used by the requester and responder will differ by a high order IV bit. For example, the MSB of the IV may be “0” for requester encryption and responder decryption and may be “1” for responder encryption and requestor decryption. This arrangement may be understood by both the requester and responder, thereby eliminating the need to exchange this information. There is no loss in functionality or security if any other IV bit is selected or if the information is exchanged.

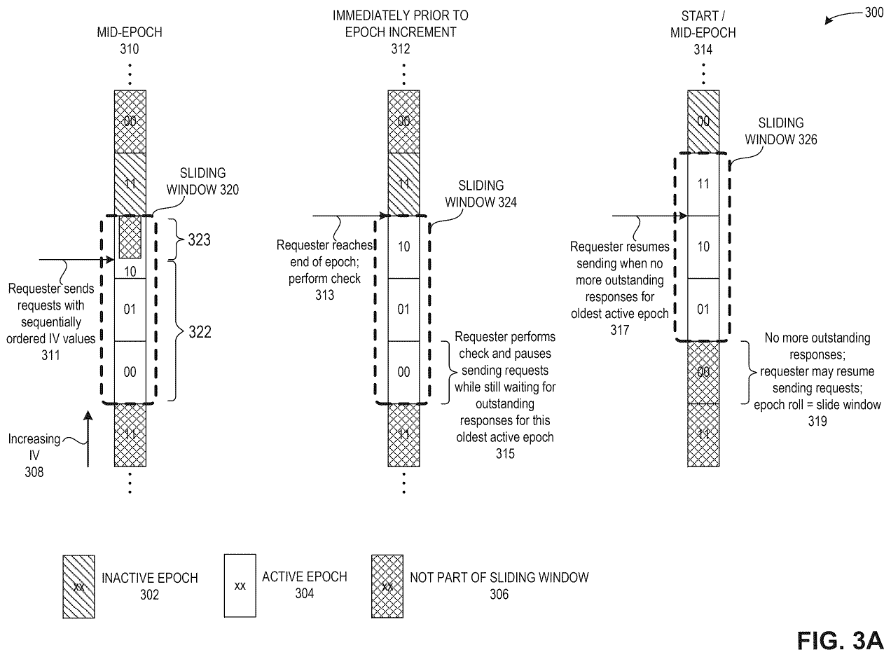

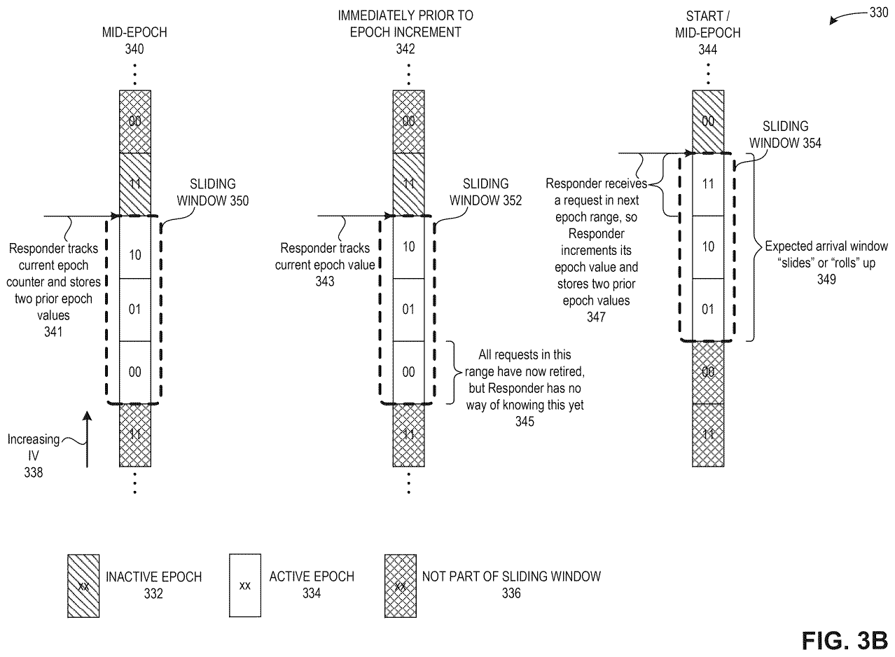

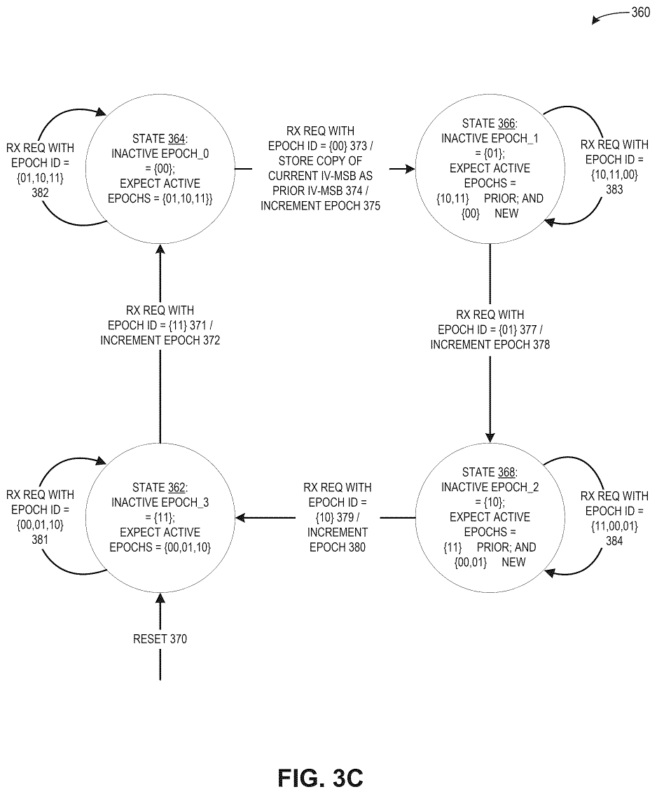

In the described aspects, both the requester and the responder may use certain bits of the IV-LSB as an “epoch identifier” (also referred to as “epoch-identifying bits”), which define a time window for a predetermined number of requests. For example, using the two most significant bits of the IV-LSB as the epoch identifier in a “four-epoch system” allows the requester to manage a sliding window of four epochs-three active and one inactive. Requests and responses may be exchanged across three active epochs simultaneously, as described below in relation to FIGS. 3A-B and 5.

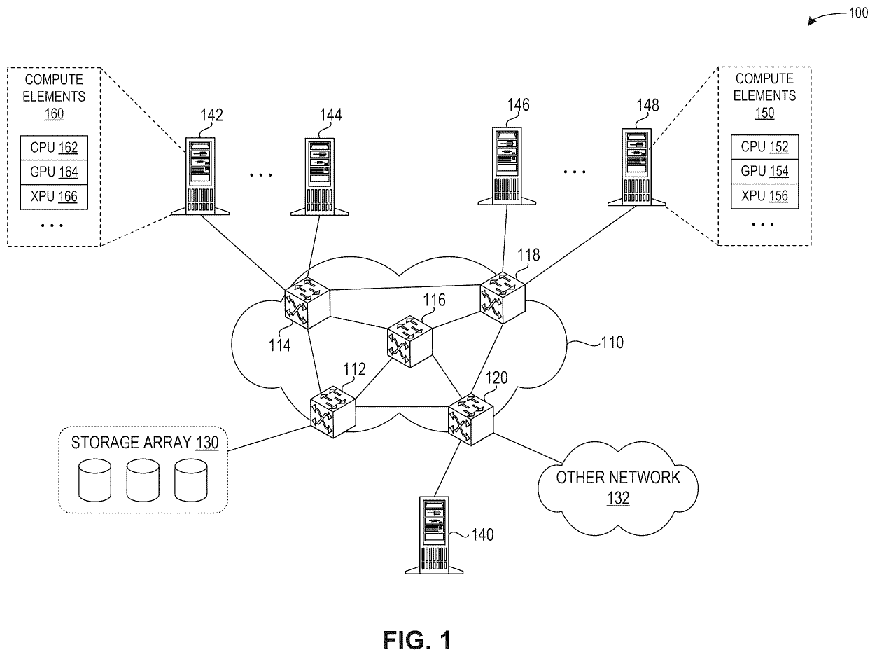

FIG. 1 illustrates an environment 100 which facilitates sliding-window based order relaxation for an encrypted channel, in accordance with an aspect of the present application. Environment 100 can include a network 110 of switches which can be referred to as a “switch fabric” or a “network fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112. An other network 132 (e.g., an HPC, Ethernet, InfiniBand, or any other network) may be coupled to switch fabric 110 via switch 120. Other network 132 may include multiple networked computer and storage devices concurrently running programs to complete different complex and performance-intensive tasks. Other network 132 may include physical Ethernet cabling and an application layer protocol between network devices based on Internet Protocol (IP), including communication via Transport Communication Protocol (TCP)/IP and User Datagram Protocol (UDP) packets. Switch fabric 110 may itself be an Ethernet network or an HPC network.

Any number of endpoints, processing nodes, compute elements, or devices with compute elements (collectively referred to as “devices”) may also be coupled to switch fabric 110, e.g.: devices 142 and 144 may be coupled to switch fabric 110 via switch 114; devices 146 and 148 may be coupled to switch fabric 110 via switch 118; and device 140 may be coupled to switch fabric 110 via switch 120. As depicted in FIG. 1, device 148 may include compute elements 150, which may include, e.g.: a central processing unit (CPU) 152; a graphics processing unit (GPU) 154; and an XPU 156, which may be any processing unit, combination of processing units, or specialized processing unit or hardware accelerator designed or optimized for a specific task. Similarly, device 142 may include compute elements 160, which may include, e.g., a CPU 162, a GPU 164, and an XPU 166. Environment 100 may include more or fewer entities coupled to switch fabric 110, and each device may include more or fewer compute elements than those depicted in compute elements 150. The entities coupled to switch fabric 110 may include a requesting node (“requester”) and a responder node (“responder”). A requester may engage in roundtrip communications over a secure encrypted channel with a responder, where each request sent by the requester expects a corresponding response from the responder. Requests and responses may flow between CPU/GPU/XPU blocks in different nodes, e.g., between 162/164/166 CPU/GPU/XPU in node 142 and 152/154/156 CPU/GPU/XPU in node 148.

In general, a switch can have edge ports and fabric ports. An edge port can couple to a device that is external to the fabric. A fabric port can couple to another switch within the fabric via a fabric link. Typically, traffic may be injected into switch fabric 110 via an ingress port of an edge switch and may leave switch fabric 110 via an egress port of another (or the same) edge switch. An ingress link can couple a NIC of an edge device (e.g., an HPC end host) to an ingress edge port of an edge switch. Switch fabric 110 can then transport the traffic to an egress edge switch, which in turn can deliver the traffic to a destination edge device via another NIC. A packet can be forwarded in switch fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110.

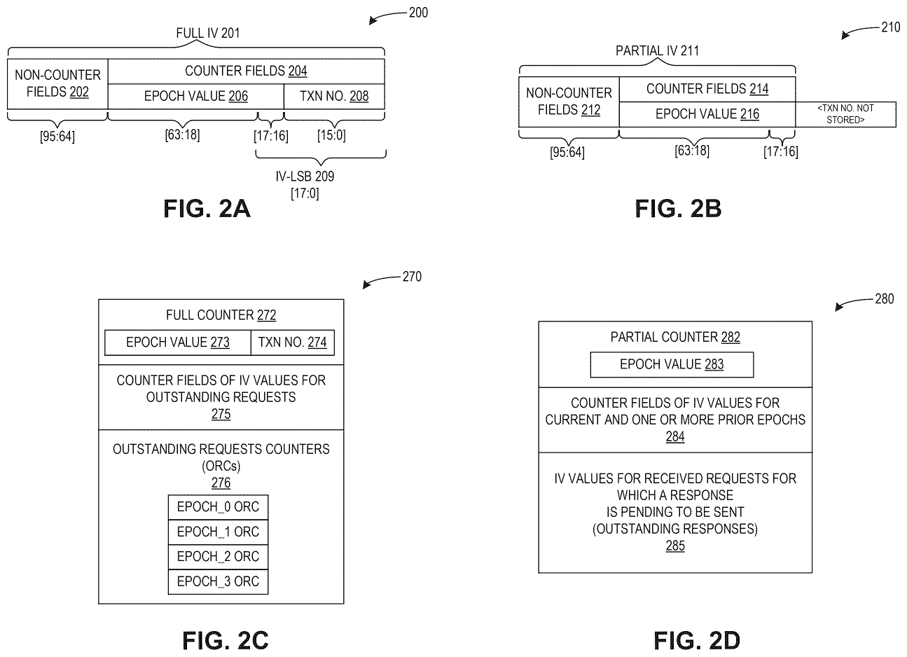

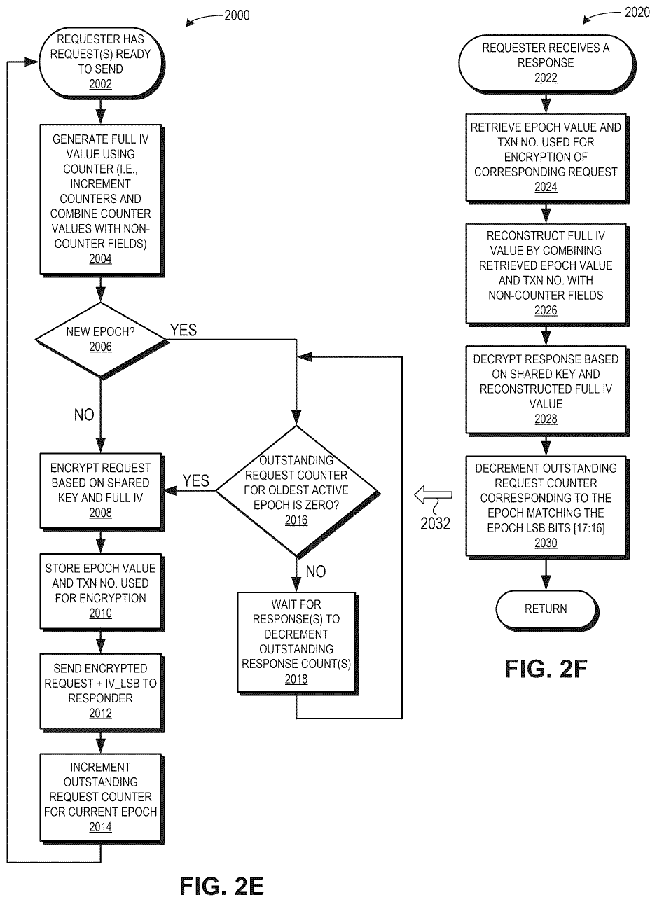

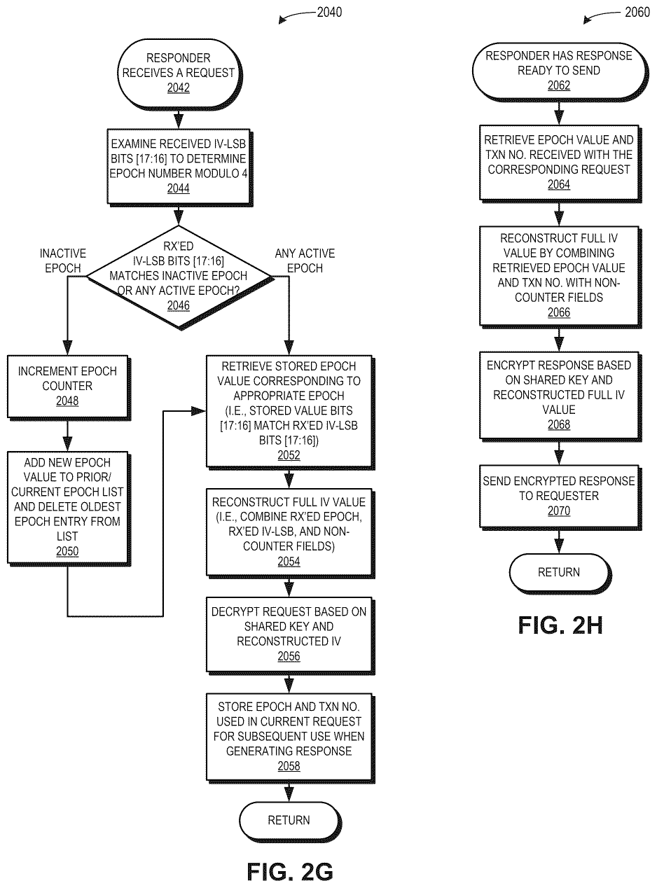

FIG. 2A illustrates a bit-field chart 200 depicting a full IV 201 maintained by a requester, in accordance with an aspect of the present application. The requester may generate full IV 201. Full IV 201 may be generated by or based on a cipher counter (e.g., a Galois counter) and may contain a varying number of bits. For example, full IV 201 may include 96 bits, such as: non-counter fields 202 [95:64]; and counter fields 204 [63:0], which includes an epoch value 206 [63:16] and a transaction number 208 [15:0]. Non-counter fields 202 may include information used by the requester, responder, or other intermediate entity, to process a message associated with full IV 201.

Counter fields 204 may be used to identify the number of requests with sequentially numbered IV-LSBs which have been sent by the requester. In addition, transaction number 208 may indicate LSBs [15:0] of full IV 201, while IV-LSB 209 [17:0] may include these transaction number LSBs [15:0] as its LSBs and may also include the LSBs [17:16] of epoch value 206 as its MSBs. These MSBs [17:16] of IV-LSB 209 [17:0] may be referred to as “epoch-identifying bits” because they may be used to unambiguously distinguish the epochs of outstanding transactions, from among the three currently active epochs (in a four-epoch system). Active epochs may be sequentially numbered, allowing epochs to be distinguished based on their modulo-4 epoch value (contained in bits [17:16] of the IV, i.e., the LSB bits [17:16] of epoch value 206).

FIG. 2B illustrates a bit-field chart 210 depicting a partial IV 211 maintained by a responder, in accordance with an aspect of the present application. The responder may maintain partial IV 211, which can include: non-counter fields 212 [95:64]; and counter fields 214, which can include an epoch value 216 [63:16]. The responder epoch value 216 may include as its LSBs epoch-identifying bits [17:16]. The responder does not track the count of each transaction number. The bit ranges listed for partial IV 211 are listed without the bottom 16 bits in order to describe the synchronization of the counter values between the requester and the responder. The actual number of bits used to store partial IV 211 may be less than the highest numbered bit depicted for partial IV 211 (e.g., listed as 95, but maintained as 95−16=79).

FIG. 2C illustrates a diagram 270 of hardware or data structures maintained by a requester, in accordance with an aspect of the present application.

The requester may include in its hardware: a full counter 272, which can generate an epoch value 273 and a transaction number 274; counter fields (e.g., 204) of IV values for outstanding requests 275, i.e., a mechanism to track the counter fields of IV values used on each outstanding request/transaction sent by the requester for which a response is still pending; and outstanding requests counters (ORCs) 276 which track the number of requests sent by the requester which are still awaiting a response. ORCs 276 may include an ORC for each epoch. For example, in a four-epoch system, ORCs 276 may include an epoch_0 ORC, an epoch_1 ORC, an epoch_2 ORC, and an epoch_3 ORC. Each ORC may be associated with an ORC value. Since, in this example, outstanding transactions at any given time may only exist in up three consecutively-numbered epochs, the epoch numbers of concurrently outstanding transactions may disambiguated by their modulo-4 value, of the two LSBs of the epoch number contained in bits [17:16] of the IV. As such, four ORCs may be sufficient for the requester to track the counts of all outstanding transactions.

FIG. 2D illustrates a diagram 280 of hardware or data structures maintained by a responder, in accordance with an aspect of the present application. The responder may include in its hardware: a partial counter 282, which can generate an epoch value 283 (e.g., indicated as bits [63:16] in FIG. 2B); counter fields of IV values for the current and one or more prior epochs 284 (also referred to as “prior epoch values”); and IV values for received requests for which a response is pending to be sent 285 (also referred to as “outstanding responses”). IV values 285 are described further below in relation to operations 2058 and 2064 in, respectively, FIGS. 2G and 2H.

FIG. 2E presents a flowchart 2000 illustrating operations by a requester in sending requests, in accordance with an aspect of the present application. The operations by the requester may begin when the requester has a request (or requests) to send (2002). The requester generates the full IV value using the counter (operation 2004). That is, the requester increments counters and combines the counter values with the non-counter fields, as described above in relation to FIG. 2A and full IV 201 comprising non-counter fields 202 and counter fields 204.

The requester determines whether a new epoch is in use (decision 2006). A new epoch may be indicated by a change in epoch value 273 resulting from a carry from transaction number field 274 during the increment operation 2004. If a new epoch is not in use, the operation continues at operation 2008. If a new epoch is in use, the requester determines whether the outstanding request counter (ORC) for the oldest active epoch is zero (decision 2016). The ORC for a plurality of epochs may be stored by the requester, e.g., as described above in relation to ORCs 276 in FIG. 2C, indicating one ORC for each epoch.

If the ORC for the oldest active epoch is zero (decision 2016), the operation continues at operation 2008. The oldest active epoch becomes inactive, and the new epoch along with the prior two epochs may be referred to as the active epochs. Transactions may only be outstanding in the active epochs. If the ORC for the oldest active epoch is not zero (decision 2016), the requester pauses and waits for received response(s) to decrement the ORC (operation 2018). Thus, decision 2016 may be a blocking action which does not unblock until all outstanding requests have received a corresponding response, as described below in relation to 313 and 315 of FIG. 3A.

If the epoch is the same and has not changed (as indicated by the “No” branch from decision 2006) or if the epoch has changed to a new epoch and the ORC for the oldest active epoch is zero (as indicated by the “Yes” branch from decision 2016), the requester encrypts the request based on the shared key and the full IV (operation 2008). The requester stores the epoch value and transaction number used for encryption of the request (operation 2010). The epoch value and transaction number may be used by the requester for subsequent decryption of the corresponding response, e.g., the counter fields of IV values for outstanding requests 285 as stored and described above in relation to FIG. 2C. The requester sends the encrypted request, along with the IV-LSB (in cleartext) to the responder (operation 2012), and the requester may increment its outstanding request counter for the current epoch (operation 2014). Flowchart 2000 is depicted as a loop because individual iterations are not independent, i.e., when the requester blocks the sending of additional requests at decision 2016 and operation 2018, both current request sending and all future request sending is blocked.

FIG. 2F presents a flowchart 2020 illustrating operations by a requester in receiving a response, in accordance with an aspect of the present application. Responses for outstanding transactions may be received in any order, independent of the order in which the corresponding requests were sent. The operations by the requester may begin when the requester receives a response (2022). The requester retrieves the epoch value and transaction number used for encryption of the corresponding request (operation 2024), e.g., as stored in 285 of FIG. 2C. The requester reconstructs the full IV value by combining the retrieved epoch value and transaction number with the non-counter fields (operation 2026). For example, the requester may retrieve the previously stored epoch value and transaction number for the request corresponding to the received response from 275 in FIG. 2C. The requester may also use non-counter fields 202 (as depicted in full IV 201 in FIG. 2A) to reconstruct the full IV.

The requester decrypts the response based on the shared key and the reconstructed full IV (operation 2028), and the requester decrements the ORC corresponding to the epoch matching the epoch LSB bits [17:16] (operation 2030). For example, the requester may decrement the ORC for epoch_2 as stored in ORCs 276 in FIG. 2C. If the response happens to match the final outstanding transaction in the oldest active epoch, then the action of decrementing the ORC for the appropriate epoch to zero may end a pause or blocking performed by the requester as part of decision 2016 an operation 2018 (as indicated by 2032). Flowchart 2020 is depicted as a linear flow rather than a loop (as in flowchart 2000) because each received response may have an independent flow. In contrast to sending requests, sequential dependency does not exist between received responses.

FIG. 2G presents a flowchart 2040 illustrating operations by a responder in receiving a request, in accordance with an aspect of the present application. The operations by the responder may begin when the responder receives a request (2042). Requests may be received by the responder in a different order versus the order they were sent by the requester. The request may be encrypted based on a shared key and a full IV, and the request may include the IV-LSB in cleartext. The responder examines the received IV-LSB bits [17:16] to determine an epoch number modulo 4 (operation 2044). For example: if the two bits are “00,” this corresponds to an epoch 0; if the two bits are “01,” this corresponds to an epoch 1; if the two bits are “10,” this corresponds to an epoch 2; and if the two are “11,” this corresponds to an epoch 3. Moving between states with certain active and inactive epochs in a four-epoch system is described below in relation to FIG. 3C.

The responder determines whether the received IV-LSB bits [17:16] matches an inactive epoch or any active epoch (decision 2046). If the received IV-LSB bits matches an inactive epoch (decision 2046), the responder may determine that an “epoch roll” has occurred, i.e., the responder has received a request whose IV-LSB bits indicate a modulo-4 epoch number that does not correspond to one of the currently active epochs. As a result, the responder increments its epoch counter (operation 2048). The responder adds the new epoch value to the prior/current epoch list (e.g., 284 in FIG. 2D) and deletes the oldest epoch entry from that list (operation 2050, as depicted above in relation to 284 in FIG. 2D). The operation continues at operation 2052.

If the received IV-LSB bits matches any active epoch (decision 2046), the responder may determine that an epoch roll has not occurred. The responder retrieves the stored epoch value corresponding to the appropriate epoch (operation 2052), i.e., the epoch value for which the stored value bits [17:16] match the IV-LSB bits [17:16] received in the request. The responder reconstructs the full IV (operation 2054), i.e., by combining the received epoch value, the received IV-LSB, and the non-counter fields. The responder decrypts the request based on the shared key and the reconstructed IV (operation 2056). The responder stores the epoch value and the transaction number used in decrypting the current request for subsequent use when generating a response to the request (operation 2058), as described above in relation to 285 in FIG. 2D. The operation returns. Flowchart 2040 is depicted as a linear flow rather than a loop (as in flowchart 2000) because there are neither sequential dependencies nor implied orderings between distinct transactions, or between request order and response order.

FIG. 2H presents a flowchart 2060 illustrating operations by a responder in sending a response, in accordance with an aspect of the present application. Responses may be sent by the responder in a different order versus the order the corresponding requests were received. The operations by the responder may begin when the responder has a response ready to send to the requester (2062). The responder retrieves the epoch value and transaction number received with the corresponding request (operation 2064), e.g., as previously stored in 285 in FIG. 2D as part of operation 2058. The responder reconstructs the full IV by combining the retrieved epoch value and transaction number with the non-counter fields (operation 2066). For example, the responder may retrieve the previously stored epoch value and transaction number for the response from 285 in FIG. 2D. The responder may also use non-counter fields 212 (as depicted in partial IV 211 in FIG. 2B) to reconstruct the full IV.

The responder encrypts the response based on the shared key and the reconstructed full IV value (operation 2068) and sends the encrypted response (without any IV-LSB in cleartext) to the requester (operation 2070). That is, the responder does not include the IV-LSB in the response. The operation returns. Flowchart 2060 is depicted as a linear flow rather than a loop (as in flowchart 2000) because there are neither sequential dependencies nor implied orderings between distinct transactions, or between request order and response order.

FIG. 3A illustrates a diagram 300 of the operations of a requester in sending requests and receiving responses based on a multi-epoch sliding window, in accordance with an aspect of the present application. In diagram 300, several snapshots in time are depicted with each epoch presented as a specifically shaded rectangle (as in the index depicting patterns 302, 304, and 306) and the full IV increasing in an upward direction (308). Each rectangle is also depicted with the value of the MSBs (epoch-identifying bits) of the requester's IV-LSB. For example, when using two bits for the epoch-identifying bits, the values of those bits may include: {00,01,10,11} in binary; or {0,1,2,3} in decimal. These values also correspond to the epoch number modulo-4.

During each snapshot, the active epochs of the sliding window are depicted with a bold dashed-line border. The sliding window may be associated with a plurality of active epochs and one inactive epoch, depending on the number of epochs tracked in a system. In the four-epoch system, for example, the sliding window may be associated with three active epochs and one currently inactive epoch. The active epochs may be depicted with no pattern fill (304), in which requests may be sent with sequentially ordered IVs and any number of the requests may still be outstanding or awaiting the corresponding response. The one currently inactive epoch may be depicted with a diagonally right-slanting line pattern (302), in which there are no outstanding requests. Epochs depicted by a cross-hatch pattern (306) are not associated with the sliding window, either because their epoch numbers have not yet been reached by the sliding window, or they have already been passed by the sliding window. These epochs contain no outstanding transactions- and necessarily so because the modulo-4 epoch-identifying bits could not unambiguously identify them if they did.

Since the sliding window comprises four consecutive epochs, epochs within the window may be unambiguously described by just the two LSBs of its epoch number. Thus, in a context where it is known to be part of the window, an epoch may be referred to based on the value of its epoch-identifying bits, e.g., the “00 epoch,” the “01 epoch,” the “10 epoch,” or the “11 epoch.” At a mid-epoch time 310, a sliding window 320 may be associated with three active epochs {00,01,10}, and the requester may be sending requests with sequentially ordered IV values (311). In sliding window 320, the current full IV may be in the active 10 epoch, where some requests have been sent and responses have arrived or are still outstanding (322), but other requests have not yet been sent (323) (i.e., there are no outstanding requests for the active 10 epoch starting from the current value of the full IV, as depicted by the cross-hatch pattern in section 323 of the 10 epoch).

At a time immediately prior to epoch increment 312, the requester reaches the end of the active 10 epoch in the sliding window 324 (i.e., the next request to be sent will use a new epoch value, based on a carry into epoch value 273 when incrementing counter 272) and performs a check before rolling to the inactive epoch (313). For example, the requester pauses sending requests and does not roll to the inactive epoch until there are no more outstanding responses in the oldest active epoch (active 00 epoch in sliding window 324) (315).

Upon determining that there are no more outstanding responses in the oldest active epoch (active 00 epoch in sliding window 324), the requester may perform an epoch roll and advance the sliding window up (to a new sliding window 326) as part of the epoch roll (319), as depicted in 314, which shows the situation at the start of the following epoch and continuing into the new epoch. That is, the requester may start sending requests in the next epoch (e.g., the 11 epoch in sliding window 326) when there are no more outstanding responses for the oldest active epoch (e.g., the 00 epoch in sliding window 324) (317). The requester may advance the sliding window by setting the oldest active epoch to an inactive epoch, e.g., as depicted by the pattern fill of the oldest active 00 epoch in sliding window 324 at time 312 changing from no pattern to a cross-hatch pattern at time 314.

FIG. 3B illustrates a diagram 330 of the operations of a responder in receiving requests and sending responses based on a multi-epoch sliding window, in accordance with an aspect of the present application. In diagram 330, several snapshots in time are depicted with each epoch presented as a specifically shaded rectangle (as in the index depicting patterns 332, 334, and 336) and the full IV increasing in an upward direction (338). Similar to diagram 300 in FIG. 3A, each rectangle is also depicted with the value of the MSBs (epoch-identifying bits) of the requester's IV-LSB, e.g., {00,01,10,11} in binary.

During each snapshot, the three active epochs of sliding window are depicted with a bold dashed-line border. The sliding window, e.g., for a four-epoch system, may be associated with three active epochs and one inactive epoch. The active epochs may be depicted with no pattern fill (334), in which requests may arrive in any order with IV values from any of the three active epochs. The responder may send responses to requests in these active epochs in any order. The one inactive epoch may be depicted with a diagonally right-slanting line pattern (332), in which no requests have arrived yet. Epochs in which the responder knows that no arrival is possible may be depicted by a cross-hatch pattern (336). No arrival of requests are possible in these epochs because they are known to fall outside of the window in which the requester is permitted to send.

At a mid-epoch time 340, a sliding window 350 may be associated with three active epochs {00,01,10}, and the responder may be tracking the current epoch value (e.g., 216 in FIG. 2B) and storing the two prior epoch values (e.g., 284 in FIG. 2D) (341). In sliding window 350, the responder tracks only the epoch value and does not track the full IV, i.e., the responder does not store the IV-LSB as part of its epoch counter value and instead only uses the IV-LSB when constructing the full IV used for request decryption and response encryption.

At a time immediately prior to epoch increment 342, the responder continues to track the current epoch value (343), and although all requests in the oldest active window have been retired (i.e., all outstanding requests have received a corresponding response in the 00 epoch of sliding window 352), the responder has no way of knowing this yet (345), nor any need to know it.

When the responder receives a request matching in the inactive epoch range (the 11 epoch in sliding window 354), the responder increments its epoch value and stores the two prior epoch values (347). The expected arrival window may “slide” or “roll up” (349) at time 344: the oldest active epoch may be set to an inactive epoch, e.g., as depicted by the pattern fill of the oldest active 00 epoch in sliding window 352 at time 342 changing from no pattern to a cross-hatch pattern at time 344; and the inactive epoch may be set to an active epoch, e.g., as depicted by the pattern fill of the next 11 epoch in sliding window 352 at time 342 changing from a right-slanting diagonal line pattern to no pattern at time 344.

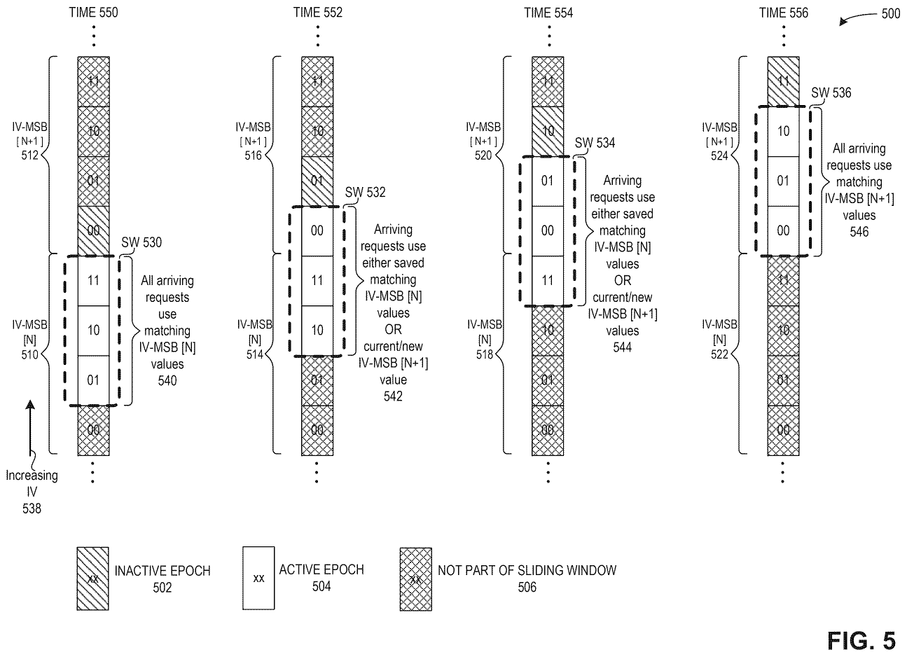

FIG. 3C illustrates a diagram 360 depicting four states of the responder, based on the exemplary four epochs in the multi-epoch sliding window of FIG. 3B, in accordance with an aspect of the present application. A description of the sliding window and appropriate IV-MSB to be used by the responder for arriving requests is provided below in relation to FIG. 5. Diagram 360 depicts a state diagram which indicates the transition between various states of the responder and advancing the sliding window depending on the sent requests and received responses in each epoch. During operation, subsequent to a reset 370 operation, the responder may begin in a state 362: inactive epoch_3={11}. In this state, the responder may expect requests to arrive in active epochs {00,01,10}, where these bits correspond to the MSBs or epoch-identifying bits of the received IV-LSB. Receiving requests in the active epochs may keep the responder in this state (as depicted by curved arrow 381 back to state 362) until the responder receives a request with the pair of epoch-identifying bits set to {11} (371). The responder may then increment its epoch value (372) and advance the expected arrival sliding window (similar to operation 349 in FIG. 3B).

The responder may then enter a state 364: inactive epoch_0={00}. In this state, the responder may expect requests to arrive in active epochs {01,10,11}, where these bits correspond to the MSBs or epoch-identifying bits of the received IV-LSB. Receiving requests in these active epochs may keep the responder in this state (as depicted by curved arrow 382 back to state 364) until the responder receives a request with the pair of epoch-identifying bits set to {00} (373). Because this signifies a “carry” or a wrap-around to a different number in the MSBs (IV-MSB) of the responder's epoch counter value, the responder may store a copy of the current IV-MSB as the prior IV-MSB as depicted above in relation to element 218 of FIG. 2. The responder may then increment its epoch value (375), advance the expected arrival sliding window (similar to operation 349 in FIG. 3B).

The responder may then enter a state 366: inactive epoch_1={01}. In this state, the responder may expect requests to arrive in active epochs {10,11} that correspond to the prior IV-MSB and in active epoch {00} that corresponds to the current IV-MSB. The responder remains in this state when it receives such requests (as depicted by curved arrow 383 back to state 366) until the responder receives a request with the pair of epoch-identifying bits set to {01} (377). The responder may then increment its epoch value (378) and advance the expected arrival sliding window (similar to operation 349 in FIG. 3B).

The responder may then enter a state 368: inactive epoch_2={10}. In this state, the responder may expect requests to arrive in active epoch {11} that corresponds to the prior IV-MSB and in active epochs {00,01} that correspond to the current IV-MSB. The responder remains in this state when it receives such requests (as depicted by curved arrow 384 back to state 368) until the responder receives a request with the pair of epoch-identifying bits set to {10} (379). The responder may then increment its epoch value (380) and advance the expected arrival sliding window (similar to operation 349 in FIG. 3B).

The responder may then enter state 362 again, and the operations are described above in relation to states 362, 364, 366, and 368 may continue, with the expected arrival sliding window advancing at each epoch roll, and with the responder using the appropriate IV-MSB depending on whether a received request corresponds to an active epoch before or after a wrap-around or carry.

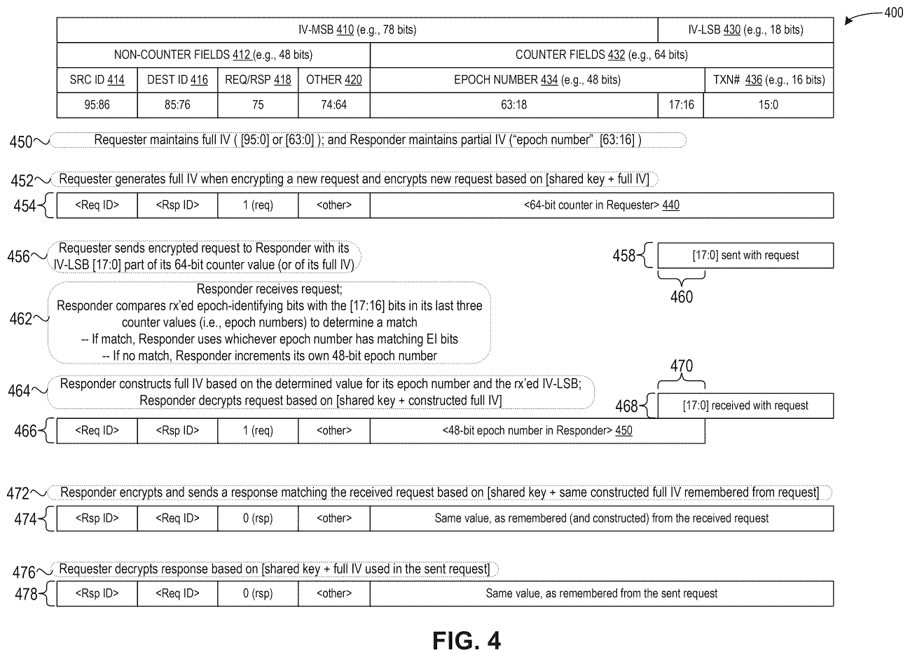

FIG. 4 illustrates a diagram 400 of how initial values (IVs) are generated, derived, and incremented by a responder and a requester, in accordance with an aspect of the present application. In diagram 400, a full IV may include: an IV-MSB 410 (e.g., 78 bits); and an IV-LSB 430 (e.g., 18 bits). The full IV may include non-counter fields 412 (e.g., 48 bits) and counter fields 432 (e.g., 64 bits). Non-counter fields 412 may include information known to both requester and responder, either because it is shared knowledge or because it is routinely communicated in request and response message fields for reasons other than IV generation. Non-counter values may assist in guaranteeing uniqueness of IV values used with any given key. For example, non-counter fields 412 may include a requester identifier (a source identifier (ID) 414 [95:86]), a responder identifier (destination ID 416 [85:76]), a type of the message 418 (e.g., request or response) [75]; and other information 420 [74:64] which may be used to further process the message. Counter fields 432 may include: an epoch number (or epoch value) 434 [63:18], with the two LSBs at [17:16] serving as epoch-identifying bits; and a transaction number 436 (e.g., 16 bits) [15:0]. IV-LSB 430 may include [17:16] (which are the two LSBs of epoch number 434) and the transaction number (e.g., a 16-bit transaction number [15:0]).

The requester generates and maintains the full IV [95:0] when considering both non-counter and counter fields or [63:0] when considering only counter fields, and the responder maintains only the partial IV [63:16], also referred to as the responder's “epoch number” or “epoch value” (operation 450). The requester generates a full IV 454 when encrypting a new request and encrypts the new request based on a shared key and the full IV (operation 452). Full IV 454 may include a requester ID, a responder ID, a flag indicating a request message, and other information in non-counter fields 412. Full IV 454 may also include the requester's 64-bit epoch number or epoch counter value (434). The requester sends the encrypted request to the responder along with, in cleartext, the IV-LSB [17:0] part of its 64-bit counter value [63:0] (or of its full IV) (operation 456). The pair of epoch-identifying bits at [17:16] (460) may be the MSBs of the cleartext-transmitted IV-LSB (458).

The responder receives the request and performs various actions (operation 462). For example, the responder compares the received pair of epoch-identifying bits with the [17:16] bits in the last three epoch counter values (i.e., epoch numbers) used and stored by the responder to determine a match. If there is a match, the responder uses whichever epoch number has matching epoch-identifying bits. If there is no match, the responder increments its own 48-bit epoch number. Comparing the received pair of bits in the cleartext-transmitted IV-LSB with the stored pair of bits in the responder's epoch counter value is described above in relation to operations 341 and 347 of FIG. 3B.

Next, the responder constructs a full IV 466 based on the determined value for its epoch number and the received IV-LSB, and also decrypts the request based on the shared key and the constructed full IV (operation 464). Full IV 466 may include the requester ID, the responder ID, the flag indicating a request message, and other information in non-counter fields 412. Full IV 466 may also include the responder's partial IV (the 48-bit epoch number or epoch value as described in operation 450) and IV-LSB 468 [17:0] received with the request. The LSBs [17:16] of the responder's epoch number (as described in operation 450) may overlap with the MSBs [17:16] of the received IV-LSB 468 [17:0].

The responder encrypts a response matching the received request based on the shared key and a same full IV 474, as constructed from the received request (472). Full IV 474 may be similar to full IV 466, but in full IV 474, instead of constructing the partial IV (i.e., the responder's epoch counter), the responder uses the same value to encrypt the response as was used to decrypt the request (472). Furthermore, some of the values in non-counter fields 412 may vary in full IV 474 as compared to full IV 466. For example, the requester ID and responder ID may be switched (to indicate the swapped source and destination), and the type of message may change from “request” to “response.” The responder sends the encrypted response to the requester (472) and does not transmit the IV-LSB [17:0] back to the requester.

The requester receives the response and decrypts the response based on its shared key and a full IV 478 used by the requester in the corresponding sent request (476). Full IV 478 may include the responder ID, the requester idea, the flag indicating a response message, and other information in non-counter fields 412. Full IV 478 may also include as the requester's [epoch counter+transaction number] the same value as used when encrypting the corresponding sent request.

FIG. 5 illustrates a diagram 500 of the operations of a responder based on a multi-epoch sliding window with three active epochs and one inactive epoch, including identification of which partial IV is used by the responder in reconstructing the full IV, in accordance with an aspect of the present application. In diagram 500, several snapshots in time are depicted with each epoch presented as a specifically shaded rectangle (as in the index depicting patterns 502, 504, and 506) and the full IV increasing in an upward direction (538). Similar to diagram 330 in FIG. 3B, each rectangle is also depicted with the value of the MSBs (epoch-identifying bits) of the requester's IV-LSB, e.g., {00,01,10,11} in binary.

During each snapshot, the three active epochs of the sliding window are depicted with a bold dashed-line border. The sliding window, e.g., for a four-epoch system, may be associated with three active epochs and one inactive epoch. The active epochs may be depicted with no pattern fill (504), in which requests may arrive in any order with IV values from any of the three active epochs. Responder may send responses to requests in these active epochs in any order, which causes the corresponding requests to be retired or marked by the requester as no longer outstanding (e.g., by decrementing the ORC value for the given epoch). The one inactive epoch may be depicted with a diagonally right-slanting line pattern (502), in which no requests have arrived yet, because there are still some outstanding requests in the oldest active epoch. Epochs in which no arrival is possible may be depicted by a cross-hatch pattern (506), in which no arrival of requests are possible.

Furthermore, all arriving requests sent based on the IV-MSB of the requester for each set of {00,01,10,11} in bits [17:16] of the requester's epoch counter may use the same upper bits [63:18] as part of the IV-MSB. As a result, bits [63:18] remain the same through four epochs in a “cycle” N, as the requester sends requests using 216 IVs for each of the four epochs denoted by {00,01,10,11} in bits [17:16]. When all active epochs are in the same such cycle N, all arriving requests may simply use the matching IV-MSB for that cycle along with the appropriate epoch-identifying bits (e.g., as depicted by IV_MSB [N] 510). When the requester advances its full IV to a value which results in a wrap-around or carry of bits in [63:18] (i.e., moves to a next cycle N+1), some arriving requests may use the IV-MSB for cycle N+1 (e.g., IV-MSB [N+1] 512), while other arriving requests may still use the IV-MSB for cycle N (e.g., IV-MSB [N] 510). The responder may determine the appropriate IV-MSB to use by determining a possible set of matching epoch identifiers comprising the LSBs of a current value of the partial IV or a value of a previous partial IV stored by the responder. The responder may further determine whether the two MSBs of the received IV-LSB match any of the possible set of matching epoch identifiers. If a match is found (denoting that the sliding window covers epochs in a same cycle), the responder constructs the full IV based on the partial IV with the two or more LSBs matching the two or more MSBs of the IV-LSB. If a match is not found (denoting that the sliding window covers epochs which span different cycles), the responder increments its partial IV and constructs the full IV based on the incremented partial IV. The responder may store the incremented partial IV. In some aspects, the responder may delete the value of a previously stored partial IV corresponding to the newly inactive epoch.

At a time 550, a sliding window 530 may be associated with three active epochs {01,10,11} in a same cycle N, which corresponds to IV-MSB [N] 510. The next cycle N+1 may be associated with four inactive epochs, which corresponds to IV-MSB [N+1] 512. The responder may track the current epoch counter and store the two prior epoch counters (i.e., IV-MSB [N] including the appropriate two epoch-identifying bits), as described above in relation to 216 and 284, respectively, in FIGS. 2B and 2D. All arriving requests use the matching IV-MSB [N] values with the appropriate epoch-identifying bits (540). The state of the responder at time 550 may correspond to state 364 in FIG. 3C.

At a time 552, the sliding window has advanced (depicted by a sliding window 532). Because the advancement of the sliding window at time 552 results in a “carry” or “wraparound” of the requester's IV-MSB (with the epoch-identifying bits [17:16] as {00}), arriving requests may use either the saved matching IV-MSB [N] 514 values or the current/new IV-MSB [N+1] value 516 (542). The state of the responder at time 550 may correspond to state 366 in FIG. 3C.

At a time 554, the sliding window has advanced (depicted by a sliding window 534). Because the advancement of the sliding window at time 554 results in requests arriving in epochs in both the prior cycle N and the current cycle N+1, the arriving requests may use either the saved matching IV-MSB [N] 518 value or the current/new IV-MSB [N+1] values 520 (544). The state of the responder at time 554 may correspond to state 368 in FIG. 3C.

At a time 556, the sliding window has advanced (depicted by a sliding window 536). Because the advancement of the sliding window at time 554 results in requests arriving in only the current N+1 cycle, all arriving requests use the matching IV-MSB [N+1] values 524 with the appropriate epoch-identifying bits (546). At this point, the IV-MSB from the prior cycle (IV-MSB [N] 522) is no longer is use, and all partial IVs associated with the prior cycle N no longer need to be stored (and may be deleted or marked to indicate free or available memory). The state of the responder at time 550 may correspond to state 362 in FIG. 3C.

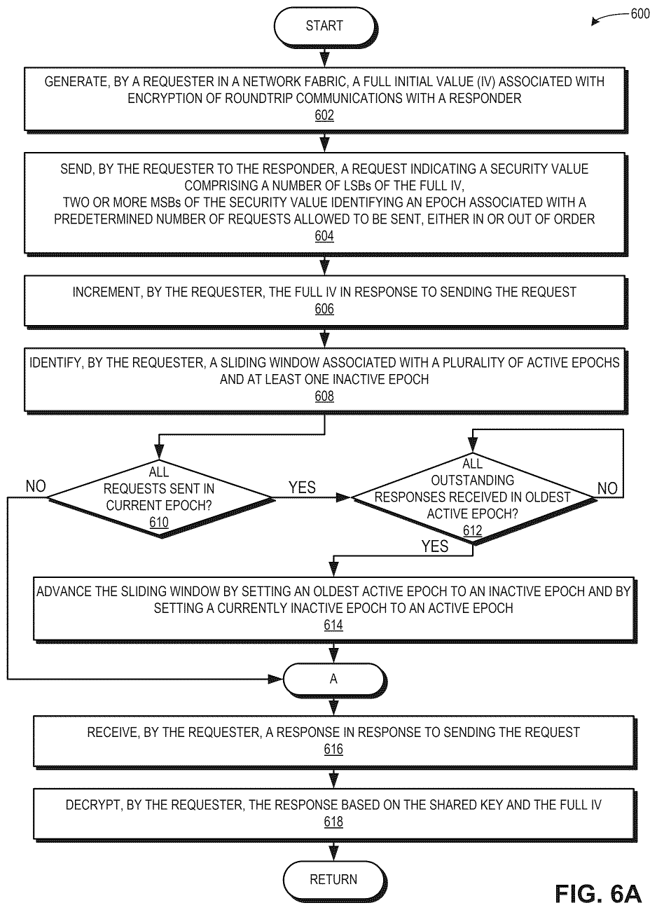

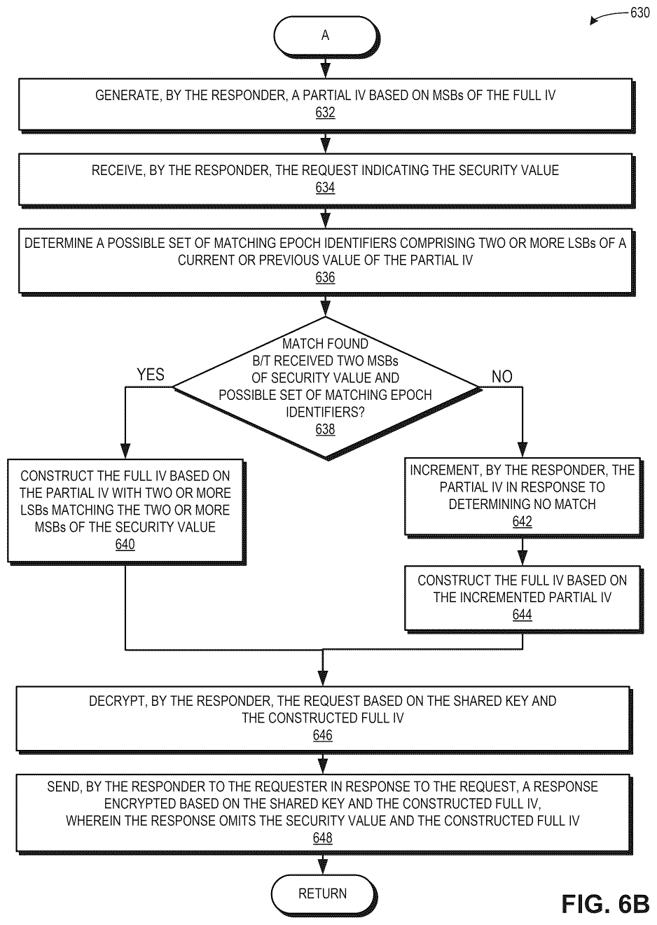

FIG. 6A presents a flowchart 600 illustrating a method which facilitates sliding-window based order relaxation for an encrypted channel, including operations by a requester, in accordance with an aspect of the present application. The system generates, by a requester in a network fabric, a full IV associated with encryption of roundtrip communications with a responder (operation 602). For example, a requester may generate a cipher counter (such as a Galois counter), also referred to as full IV 201 which includes both non-counter field 202 and counter fields 204. The initial value of the full IV may be a value agreed-upon by the requester and the responder, e.g., all zeros, a number that fits within the width of a number of bits comprising the full IV, or some other predetermined number. The requester may maintain the full IV and the responder may maintain a partial IV, as described above in relation to 450 of FIG. 4. The requester and responder may also use a shared key, which has been agreed-upon or determined prior to transmitting the encrypted requests and responses.

The system sends, by the requester to the responder, a request indicating a security value comprising a number of least significant bits (LSBs) of the full IV, two or more most significant bits (MSBs) of the security value identifying an epoch associated with a predetermined number of requests allowed to be sent, either in order or out of order, by the requester to the responder (operation 604). For example, the requester may perform an operation which generates and encrypts a request based on a shared key and the full IV, and the requester may send the encrypted request, along with the IV-LSB (in cleartext) to the responder, as described above in relation to operations 2004, 2008, and 2012 in FIG. 2E

The system may increment, by the requester, the full IV in response to sending the request (operation 606). For example, the requester may increment its full IV in response to sending the request, as described above in relation to the loop operations in flowchart 2000 in FIG. 2E.

The system identifies, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent (operation 608). For example, in FIG. 3A at time 310, the requester may identify three active epochs {00,01,10} and one inactive epoch {11}, where the active epochs and the inactive epoch are depicted based on specific shadings or fill patterns (as described above in relation to 302, 304, and 306 of FIG. 3A).

The system, by the requester, determines whether all requests have been sent in the current epoch (i.e., the most recent active epoch (decision 610). If all requests have not been sent in the current epoch (decision 610), the operation continues at Label A in FIG. 6B (depicting operations by the responder), as no additional determinations regarding the sliding of the window need to be made at this point. That is, because there are still requests (in the predetermined number of requests) remaining to be sent by the requester, the requester does not need to perform this first condition or check relating to determining whether the sliding window is to be advanced. If all requests have been sent in the current epoch (decision 610), the system proceeds to determine whether all outstanding responses have been received in the oldest active epoch (decision 612). For example, in FIG. 3A, the requester reaches the end of an epoch by sending the predetermined number (e.g., 216) of requests (where this first condition or check yields a “Yes” result from decision 610) and performs the check of whether all outstanding responses have been received in the oldest active epoch, as in decision 612 and as described above in relation to operation 313 of FIG. 3A.

If all outstanding responses have not been received in the oldest active epoch (decision 612), the requester pauses sending any requests (i.e., pauses before an epoch roll or before advancing the sliding window, as depicted by the “No” branch back to decision 612) while waiting for any outstanding responses for the oldest active epoch. For example, as depicted above in relation to FIG. 3A, the requester may pause sending requests and does not roll to the inactive epoch until there are no more outstanding responses in the oldest active epoch (e.g., active 00 epoch in sliding window 324 at time 312 and in operation 315). As described above in relation to FIGS. 2E-H, the requester may increment a respective outstanding request counter (ORC) value for each active epoch in the sliding window upon sending a request, and may also decrement the respective ORC value upon receiving a response to the request.

If all outstanding responses have been received in the oldest active epoch (decision 612), the requester advances the sliding window by setting an oldest active epoch to an inactive epoch and by setting a currently inactive epoch to an active epoch (operation 614), as depicted above in relation to advancing the sliding window from sliding window 324 at time 312 to sliding window 326 at time 314. The operation continues at Label A of FIG. 6B (describing operations by the responder) and subsequently continues at operation 616 after the operations at Label A have completed. The system receives, by the requester, a response in response to sending the request (operation 616). For example, the requester may receive a response and may begin operations 2024-2030 as depicted above in relation to flowchart 2020 in FIG. 2F. The response may correspond to a previously sent request, which may be determined by operations 2024 and 2026 in FIG. 2F.

The system decrypts, by the requester, the response based on the shared key and the full IV (operation 618). The requester may decrypt the received response based on the shared key and full IV previously used to encrypt the corresponding request, as described above in relation to operation 2028 in FIG. 2F. As another example, the requester may decrypt the response (as in operation 476) based on the shared key and the full IV 478, as described above in relation to FIG. 4. The operation returns.

FIG. 6B presents a flowchart 630 illustrating a method which facilitates sliding-window based order relaxation for an encrypted channel, including operations by a responder, in accordance with an aspect of the present application. The system generates, by the responder, a partial IV based on most significant bits (MSBs) of the full IV (operation 632). The responder may generate a partial IV based on the full IV, i.e., based on a previously agreed-upon starting or initial value. As depicted above in FIGS. 2A-D, partial IV 211 maintained by the responder may include non-counter fields 212 and counter fields 214, and may be based on the MSBs (non-counter fields 202 [95:64] and epoch counter 206 [63:16] of counter fields 204) of full IV 201.

The system receives, by the responder, the request indicating the security value (operation 634). For example, in FIG. 4, the responder receives the encrypted request with the IV-LSB in cleartext (462 in FIG. 4). The requester may have encrypted the request using the shared key and the full IV, but the requester only transmits a portion of the full IV (i.e., the IV-LSB) across the wire to the responder.

The responder constructs the full IV based on the partial IV, the security value, and a plurality of previous partial IVs stored by the responder. Specifically, the system determines a possible set of matching epoch identifiers comprising two or more LSBs of a current or previous value of the partial IV (operation 636). For example, the responder may compare the received pair of epoch-identifying bits with the [17:16] bits in the last three epoch counter values (i.e., epoch numbers) used and stored by the responder to determine a match.

If a match is found between the received two MSBs of the security value and the possible set of matching epoch identifiers (decision 638), the responder constructs the full IV based on the partial IV with two or more LSBs matching the two or more MSBs of the security value (operation 640). The responder may determine whether a match is found as part of receiving, processing, or handling the request (received in operation 634). For example, after comparing the received pair of epoch-identifying bits with the [17:16] bits in the last three epoch counter values (i.e., epoch numbers) used and stored by the responder, if a match is found, the responder uses whichever epoch number has matching epoch-identifying bits, e.g., one of the tracked or stored partial IVs as in 284 of FIG. 2D. Operations performed by a responder in receiving a request are described above in relation to operations 2042 and 2044 as well as decision 2046 of FIG. 2G. The operation continues at operation 646.

If a match is not found between the received two MSBs of the security value and the possible set of matching epoch identifiers (decision 638), the responder increments the partial IV in response to determining no match (operation 642). As described above in relation to FIG. 4, if there is no match, this may indicate that the requester has performed an epoch roll after performing a check (as described above in relation to 313, 315, and 317 of FIG. 3A), as the responder has received a request from a new epoch. Consequently, the responder may increment its own 48-bit epoch number, e.g., as described above in relation to 216 in FIG. 2B and operation 462 by responder in FIG. 4.

The responder constructs the full IV based on the incremented partial IV (operation 644), similar to operation 640 but using the incremented partial IV instead of the matching partial IV. For example, the responder may determine its partial IV, based on non-counter fields 212 and responder's epoch value 216 (i.e., the incremented partial IV). The responder may construct the full IV by combining the epoch value with or prepending as bits to the received transaction number [15:0], which was previously received as IV-LSB 209 [17:0] from the requester. Constructing the full IV is also described above in relation to operation 2054 and 2066 in, respectively, FIGS. 2G and 2H as well as in operation 464 performed by the responder in FIG. 4.

The system decrypts, by the responder, the request based on a shared key and the constructed full IV (operation 646). As depicted above in relation to operation 464 in FIG. 4, the responder may decrypt the request based on the shared key and the constructed full IV.

The system sends, by the responder, to the requester in response to the request, a response encrypted based on the shared key and the constructed full IV, wherein the response omits the security value and the constructed full IV (operation 648). The responder may obtain or generate a response to the decrypted request send back a response to the requester, where the response is encrypted using the same [key+IV] pair used by the responder to decrypt the request. For example, in FIG. 4, the responder encrypts and sends a response matching (i.e., corresponding to or in response to) the received request, in operation 472 based on full IV 474. The operation returns, i.e., continues back in FIG. 6A at operation 608, which includes operations performed by the requester after receiving the response sent by the responder.

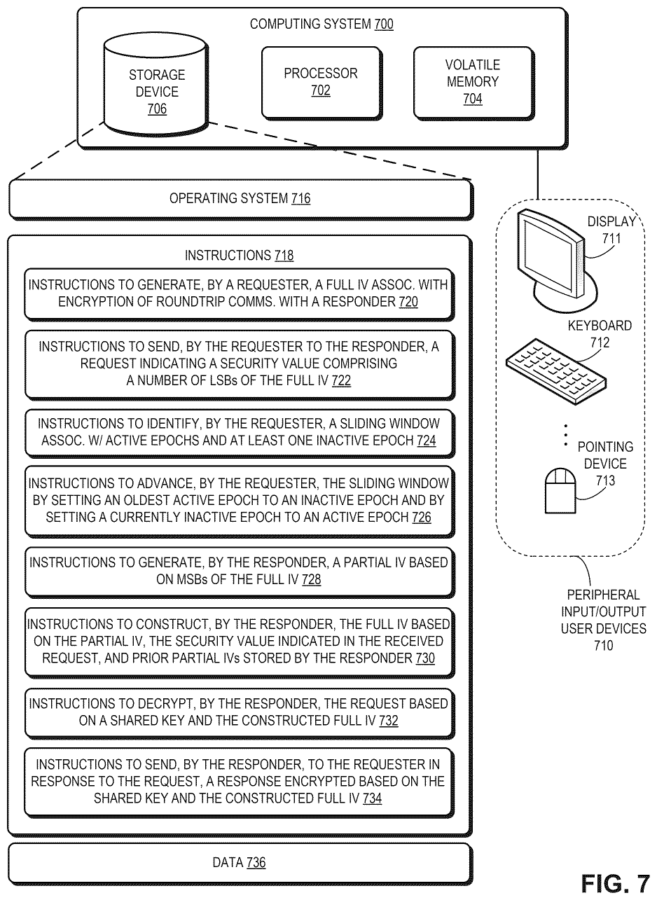

FIG. 7 illustrates a computing system 700 which facilitates sliding-window based order relaxation for an encrypted channel, in accordance with an aspect of the present application. Computing system 700 includes a processor 702, a memory 704, and a storage device 706. Memory 704 may include a volatile memory (e.g., random access memory (RAM)) that serves as a managed memory and can be used to store one or more memory pools. Furthermore, computing system 700 may be coupled to peripheral I/O user devices 710 (e.g., a display device 711, a keyboard 712, and a pointing device 713). Storage device 706 includes non-transitory computer-readable storage medium and stores an operating system 716, instructions 718, and data 736. Computing system 700 may include fewer or more entities or instructions than those shown in FIG. 7.

Instructions 718, when executed by computing system 700, can cause computing system 700 to perform methods and/or processes described in this disclosure. Instructions 718 may include instructions performed by a requester (or by requester functionality in computing system 700), e.g., instructions 720-726). Instructions 718 may also include instructions performed by a responder (or by responder functionality in computing system 700), e.g., instructions 728-734. Specifically, instructions 718 may include instructions 720 to generate, by a requester in a network fabric, a full IV associated with encryption of roundtrip communications with a responder, as described above in relation to operation 602 of FIG. 6A.

Instructions 718 may also include instructions 722 to send, by the requester to the responder, a request indicating a security value comprising a number of least significant bits (LSBs) of the full IV. Two or more most significant bits (MSBs) of the security value may identify an epoch associated with a predetermined number of requests allowed to be sent, either in order or out of order, by the requester to the responder, as described above in relation to operation 604 of FIG. 6A.

Instructions 718 may also include instructions 724 to identify, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent, as described above in relation to operation 612 of FIG. 6A.

Instructions 718 may further include instructions 726 to advance, by the requester, the sliding window by setting an oldest active epoch to an inactive epoch and by setting a currently inactive epoch to an active epoch, as described above in relation to operation 616 of FIG. 6A.

Furthermore, instructions 718 may include instructions 728 to generate, by the responder, a partial IV based on most significant bits (MSBs) of the full IV, as described above in relation to operation 632 of FIG. 6B.

Instructions 718 may further include instructions 730 to construct, by the responder, the full IV based on the partial IV, the security value indicated in the received request, and a plurality of previous partial IVs stored by the responder, as described above in relation to operation 636, decision 638, and operations 640-644 of FIG. 6B.

Instructions 718 may include instructions 732 to decrypt, by the responder, the request based on a shared key and the constructed full IV, as described above in relation to operation 646 of FIG. 6B.

Instructions 718 may also include instructions 734 to send, by the responder, to the requester in response to the request, a response encrypted based on the shared key and the constructed full IV, as described above in relation to operation 648 of FIG. 6B.

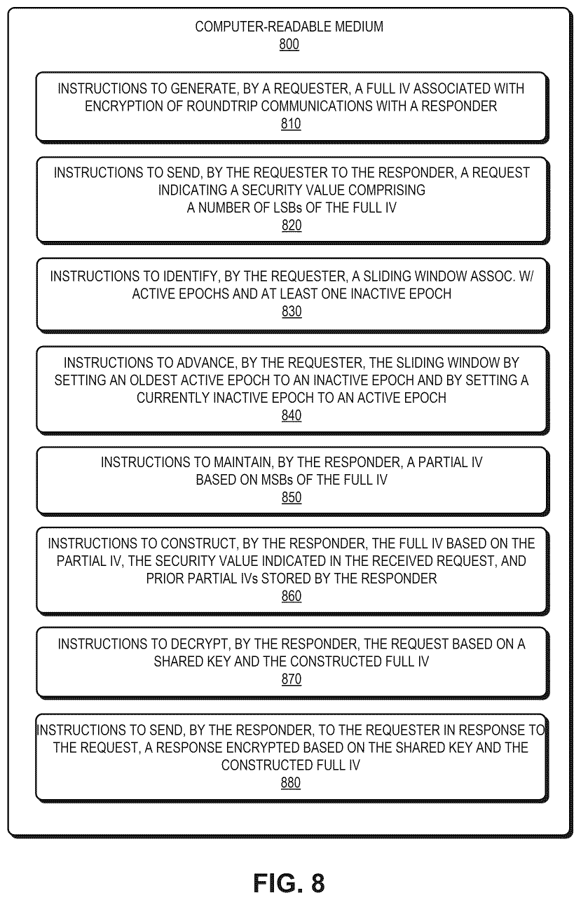

Instructions 718 may include more instructions than those shown in FIG. 7. For example, instructions 718 may include instructions for executing the operations described above in relation to: the flowcharts of FIGS. 2E-H; the sliding windows of FIGS. 3A-B and 5; the state diagram of FIG. 3C; the generation, tracking, and maintaining of the full IV and the partial IV in FIG. 4; the operations in FIGS. 6A-B; and the instructions of CRM 800 in FIG. 8.

Data 736 can include any data that is required as input or that is generated as output by the methods, operations, communications, and/or processes described in this disclosure. Specifically, data 736 can store at least: a request; a security value; a sequentially ordered security value; a response; an initial value (IV); a counter value; a full IV; a constructed full IV; an incremented IV value; a partial IV; a current or previous partial IV value; one or more MSBs or LSBs; a predetermined number; an identifier or indicator of an epoch corresponding to a time window in which a certain number of requests may be sent; an indicator of an active or inactive epoch; an encrypted request or response; a shared key; an epoch-identifier; epoch-identifying bits; a set of matching epoch-identifiers; non-counter fields; counter fields; an IV-MSB; an IV-LSB; an epoch counter; an epoch counter value; an epoch number; a transaction number; a number of outstanding responses; an outstanding requests counter value; a number of requests sent in an epoch; an outstanding responses counter value; and a number of corresponding responses received in an epoch.

FIG. 8 illustrates a computer-readable medium (CRM) 800 which facilitates sliding-window based order relaxation for an encrypted channel, in accordance with an aspect of the present application. CRM 800 can be a non-transitory computer-readable medium or device storing instructions that when executed by a computer or processor cause the computer or processor to execute the instructions or perform a method. CRM 800 may store instructions 810 to generate, by a requester in a network fabric, a full IV associated with encryption of roundtrip communications with a responder, as described above in relation to operation 602 of FIG. 6A

CRM 800 may store instructions 820 to send, by the requester to the responder, a request indicating a security value comprising a number of least significant bits (LSBs) of the full IV. Two or more most significant bits (MSBs) of the security value may identify an epoch associated with a predetermined number of requests allowed to be sent, either in order or out of order, by the requester to the responder. Sending the request, the security value, and overlapping LSBs and MSBs are described above in relation to operation 604 of FIG. 6A.

CRM 800 may store instructions 830 to identify, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent, as described above in relation to operation 612 of FIG. 6A.

CRM 800 may store instructions 840 to advance, by the requester, the sliding window by setting an oldest active epoch to an inactive epoch and by setting a currently inactive epoch to an active epoch, as described above in relation to operation 616 of FIG. 6A.

Furthermore, CRM 800 may store instructions 850 to maintain, by the responder, a partial IV based on most significant bits (MSBs) of the full IV, as described above in relation to operation 632 of FIG. 6B.

CRM 800 may store instructions 860 construct, by the responder, the full IV based on the partial IV, the security value indicated in the received request, and a plurality of previous partial IVs stored by the responder, as described above in relation to operation 636, decision 638, and operations 640-644 of FIG. 6B.

CRM 800 may store instructions 870 to decrypt, by the responder, the request based on a shared key and the constructed full IV, as described above in relation to operation 646 of FIG. 6B.

CRM 800 may store instructions 880 to send, by the responder, to the requester in response to the request, a response encrypted based on the shared key and the constructed full IV, as described above in relation to operation 648 of FIG. 6B.

CRM 800 may include more instructions than those shown in FIG. 8. For example, CRM 800 may also store instructions for executing the operations described above in relation to: the flowcharts of FIGS. 2E-H; the sliding windows of FIGS. 3A-B and 5; the state diagram of FIG. 3C; the generation, tracking, and maintaining of the full IV and the partial IV in FIG. 4; the operations in FIGS. 6A-B; and the instructions of computing system 700 in FIG. 7.

The term “network device” refers to any device, component, or computing entity which can provide a communication pipeline for packets sent from a “processing node” or an “endpoint node.” An example of a network device may be a switch, as described above in relation to FIG. 1. A processing or endpoint node may refer to a device, component, or hardware component which can operate as a source or a destination of data, including e.g., a control packet or a data packet. A processing node or endpoint node may be referred to as a “requester” or a “responder.” A requester and a responder may transmit data (e.g., a request or a response) to each other over the communication pipeline as a roundtrip communication. The requester may generate and send an encrypted request to the responder. The responder may decrypt the request, generate a response, and send an encrypted response back to the requester. The requester may subsequently decrypt the response. Accordingly, the requester and the responder may each be an endpoint for data sent across the communication pipeline (e.g., a network fabric such as fabric 110 in FIG. 1). Additionally, an endpoint node or processing node may serve as both a requester and a responder. That is, an endpoint or processing node may include both requester functionality and responder functionality, as described herein, including at, e.g., FIG. 4 describing the operations and communications of a requester and a responder with respect to the IV-MSB 410 and IV-LSB 430.

In general, the disclosed aspects provide a method, a computing system, and a computer-readable medium which facilitate sliding-window based order relaxation for an encrypted channel. In one aspect, the system generates, by a requester in a network fabric, a full IV associated with encryption of roundtrip communications with a responder. The system sends, by the requester to the responder, a request indicating a security value comprising a number of least significant bits (LSBs) of the full IV. Two or more most significant bits (MSBs) of the security value identify an epoch associated with a predetermined number of requests allowed to be sent, either in order or out of order, by the requester to the responder. The system identifies, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent. The system advances, by the requester, the sliding window by setting an oldest active epoch to an inactive epoch and by setting a currently inactive epoch to an active epoch.

In a variation on this aspect, the system, by the requester, encrypts the request based on a shared key and the full IV. The requester increments the full IV in response to sending the request. The requester receives a response in response to sending the request to the responder. The requester decrypts the response based on the shared key and the full IV used by the requester to encrypt the request.

In a further variation on this aspect, the system generates, by the responder, a partial IV based on most significant bits (MSBs) of the full IV. The system receives, by the responder, the request indicating the security value. The system constructs, by the responder, the full IV based on the partial IV, the security value, and a plurality of previous partial IVs stored by the responder. The system decrypts, by the responder, the request based on a shared key and the constructed full IV. The system sends, by the responder, to the requester in response to the request, a response encrypted based on the shared key and the constructed full IV.

In a further variation, the responder sends the response without including the security value or the constructed full IV.

In a further variation, the responder constructs the full IV by performing the following operations. The responder determines a possible set of matching epoch identifiers comprising two or more least significant bits (LSBs) of at least one of: a current value of the partial IV; or a value of a previous partial IV stored by the responder. The responder determines whether the received two or more MSBs of the security value match any of the possible set of matching epoch identifiers.

In a further variation, the responder constructs the full IV by performing the following operations. In response to determining a match, the responder constructs the full IV based on the partial IV with two or more LSBs matching the two or more MSBs of the security value.

In a further variation, the responder constructs the full IV by performing, in response to not determining a match, the following operations. The responder increments the partial IV. The responder constructs the full IV based on the incremented partial IV. The responder stores the incremented partial IV. The responder deletes the value of a previously stored partial IV corresponding to the currently inactive epoch.

In a further variation, the requester advances the sliding window in response to: sending the predetermined number of requests for the most recent active epoch; and determining that outstanding responses have been received to all requests sent for the oldest active epoch.

In a further variation, the requester determines a number of outstanding responses by tracking a number of requests sent and corresponding responses received for each active epoch.

In a further variation, the security value comprises 18 of the LSBs of the full IV. The sliding window is associated with four epochs including three active epochs and one inactive epoch. The epoch-identifying bits of the security value comprise two bits which identify one of the four epochs in the sliding window. A respective epoch corresponds to a time window in which 216 requests indicating sequentially ordered security values are sent by the requester to the responder

In a further variation, the predetermined number of requests may be sent either in order or out of order by the requester to the responder. Responses corresponding to the predetermined number of requests may be sent either in order or out of order by the responder to the requester. The responses corresponding to the predetermined number of requests may be received either in order or out of order by the requester from the responder.

In another aspect, a computing system comprises a processing resource and a storage device storing instructions which when executed by the processing resource cause the processing resource to perform a method, e.g., instructions 718 in FIG. 7. The instructions or method may be performed by a requester or a responder. The instructions are to generate, by a requester in a network fabric, a full IV associated with encryption of roundtrip communications with a responder. The instructions are further to send, by the requester to the responder, a request indicating a security value comprising a number of least significant bits (LSBs) of the full IV, two or more most significant bits (MSBs) of the security value identifying an epoch associated with a predetermined number of requests allowed to be sent, either in order or out of order, by the requester to the responder. The instructions are further to identify, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent. The instructions are further to advance, by the requester, the sliding window by setting an oldest active epoch to an inactive epoch and by setting a currently inactive epoch to an active epoch.

The instructions in the computing system are further to generate, by the responder, a partial IV based on most significant bits (MSBs) of the full IV. The instructions are further to receive, by the responder, the request indicating the security value. The instructions are further to construct, by the responder, the full IV based on the partial IV, the security value, and a plurality of previous partial IVs stored by the responder. The instructions are further to decrypt, by the responder, the request based on a shared key and the constructed full IV. The instructions are further to send, by the responder, to the requester in response to the request, a response encrypted based on the shared key and the constructed full IV.

The computing system may also include additional instructions, including in relation to: the flowcharts of FIGS. 2E-H; the sliding windows of FIGS. 3A-B and 5; the state diagram of FIG. 3C; the generation, tracking, and maintaining of the full

IV and the partial IV in FIG. 4; the operations in FIGS. 6A-B; and the instructions of CRM 800 in FIG. 8.

In another aspect, a non-transitory computer-readable storage medium (or CRM) stores instructions to perform a method. The instructions or method may be performed by a requester or a responder. The instructions are to generate, by a requester in a network fabric, a full IV associated with encryption of roundtrip communications with a responder. The instructions are further to send, by the requester to the responder, a request indicating a security value comprising a number of least significant bits (LSBs) of the full IV, two or more most significant bits (MSBs) of the security value identifying an epoch associated with a predetermined number of requests allowed to be sent, either in order or out of order, by the requester to the responder. The instructions are further to identify, by the requester, a sliding window associated with: a plurality of active epochs corresponding to a time window in which the predetermined number of requests are currently allowed to be sent; and at least one inactive epoch corresponding to a time window in which the predetermined number of requests are currently not allowed to be sent. The instructions are further to advance, by the requester, the sliding window by setting an oldest active epoch to an inactive epoch and by setting a currently inactive epoch to an active epoch.

The instructions in the CRM are further to generate, by the responder, a partial IV based on most significant bits (MSBs) of the full IV. The instructions are further to receive, by the responder, the request indicating the security value. The instructions are further to construct, by the responder, the full IV based on the partial IV, the security value, and a plurality of previous partial IVs stored by the responder. The instructions are further to decrypt, by the responder, the request based on a shared key and the constructed full IV. The instructions are further to send, by the responder, to the requester in response to the request, a response encrypted based on the shared key and the constructed full IV.

The CRM may also include additional instructions, including in relation to: the flowcharts of FIGS. 2E-H; the sliding windows of FIGS. 3A-B and 5; the state diagram of FIG. 3C; the generation, tracking, and maintaining of the full IV and the partial IV in FIG. 4; the operations in FIGS. 6A-B; and the instructions of computing system 700 in FIG. 7.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
generating, by a requester in a network fabric, a full initial value (IV) associated with encryption of roundtrip communications with a responder;
sending, by the requester to the responder, a request indicating a security value comprising:
a number of least significant bits (LSBs) of the full IV, and
two or more most significant bits (MSBs) of the security value identifying an epoch associated with a predetermined number of requests allowed to be sent by the requester to the responder;
identifying, by the requester, a sliding window associated with:
a plurality of active epochs corresponding to a time window in which the predetermined number of requests are currently allowed to be sent; and
at least one inactive epoch corresponding to a time window in which the predetermined number of requests are currently not allowed to be sent; and
advancing, by the requester, the sliding window by setting an oldest active epoch to an inactive epoch and by setting a currently inactive epoch to an active epoch.

2. The method of claim 1, further comprising:
encrypting the request based on a shared key and the full IV;
incrementing the full IV in response to sending the request;
receiving a response in response to sending the request to the responder; and
decrypting the response based on the shared key and the full IV used by the requester to encrypt the request.

3. The method of claim 1, further comprising:
generating, by the responder, a partial IV based on most significant bits (MSBs) of the full IV;
receiving, by the responder, the request indicating the security value;
constructing, by the responder, the full IV based on the partial IV, the security value, and a plurality of previous partial IVs stored by the responder;
decrypting, by the responder, the request based on a shared key and the constructed full IV; and
sending, by the responder, to the requester in response to the request, a response encrypted based on the shared key and the constructed full IV.

4. The method of claim 3, further comprising:
sending, by the responder, the response, wherein the response does not include the security value and the constructed full IV.

5. The method of claim 3, wherein constructing the full IV comprises:
determining a possible set of matching epoch identifiers comprising two or more least significant bits (LSBs) of at least one of:
a current value of the partial IV; or
a value of a previous partial IV stored by the responder; and
determining whether the received two or more MSBs of the security value match any of the possible set of matching epoch identifiers.

6. The method of claim 5, wherein constructing the full IV further comprises:
in response to determining a match, constructing the full IV based on the partial IV with two or more LSBs matching the two or more MSBs of the security value.

7. The method of claim 5, wherein constructing the full IV further comprises:
in response to not determining a match:
incrementing the partial IV;
constructing the full IV based on the incremented partial IV;
storing the incremented partial IV; and
deleting the value of a previously stored partial IV corresponding to the currently inactive epoch.

8. The method of claim 1,
wherein advancing the sliding window is in response to:
sending the predetermined number of requests for the most recent active epoch; and
determining that outstanding responses have been received to all requests sent for the oldest active epoch.

9. The method of claim 1, further comprising:
determining a number of outstanding responses by tracking a number of requests sent and corresponding responses received for each active epoch.

10. The method of claim 1,
wherein the security value comprises 18 of the LSBs of the full IV;
wherein the sliding window is associated with four epochs including three active epochs and one inactive epoch;
wherein the epoch-identifying bits of the security value comprise two bits which identify one of the four epochs in the sliding window; and
wherein a respective epoch corresponds to a time window in which 2\hat{ }16 requests indicating sequentially ordered security values are sent by the requester to the responder.

11. The method of claim 1,
wherein the predetermined number of requests may be sent either in order or out of order by the requester to the responder;
wherein responses corresponding to the predetermined number of requests may be sent either in order or out of order by the responder to the requester; and
wherein the responses corresponding to the predetermined number of requests may be received either in order or out of order by the requester from the responder.

12. A computing system comprising:
a processing resource; and
a storage device storing instructions which when executed by the processing resource cause the processing resource to perform a method, the method comprising:
generating, by a requester in a network fabric, a full initial value (IV) associated with encryption of roundtrip communications with a responder;
sending, by the requester to the responder, a request indicating a security value comprising:
a number of least significant bits (LSBs) of the full IV, and
two or more most significant bits (MSBs) of the security value identifying an epoch associated with a predetermined number of requests allowed to be sent by the requester to the responder; identifying, by the requester, a sliding window associated with:
a plurality of active epochs corresponding to a time window in which the predetermined number of requests are currently allowed to be sent; and
at least one inactive epoch corresponding to a time window in which the predetermined number of requests are currently not allowed to be sent; and
advancing, by the requester, the sliding window by setting an oldest active epoch to an inactive epoch and by setting a currently inactive epoch to an active epoch.

13. The computing system of claim 12, the method further comprising:
encrypting the request based on a shared key and the full IV;
incrementing the full IV in response to sending the request;
receiving a response in response to sending the request to the responder; and
decrypting the response based on the shared key and the full IV used by the requester to encrypt the request.

14. The computing system of claim 12, the method further comprising:
generating, by the responder, a partial IV based on most significant bits (MSBs) of the full IV;
receiving, by the responder, the request indicating the security value;
constructing, by the responder, the full IV based on the partial IV, the security value, and a plurality of previous partial IVs stored by the responder;
decrypting, by the responder, the request based on a shared key and the constructed full IV; and
sending, by the responder, to the requester in response to the request, a response encrypted based on the shared key and the constructed full IV, wherein the response omits the security value or the constructed full IV.

15. The computing system of claim 14, wherein constructing the full IV comprises:
determining a possible set of matching epoch identifiers comprising two or more least significant bits (LSBs) of at least one of:
a current value of the partial IV; or
a value of a previous partial IV stored by the responder; and
determining whether the received two or more MSBs of the security value match any of the possible set of matching epoch identifiers.

16. The computing system of claim 15, wherein constructing the full IV further comprises:
in response to determining a match, constructing the full IV based on the partial IV with two or more LSBs matching the two or more MSBs of the security value; and
in response to not determining a match:
incrementing the partial IV;
constructing the full IV based on the incremented partial IV;
storing the incremented partial IV; and
deleting the value of a previously stored partial IV corresponding to the currently inactive epoch.

17. The computing system of claim 12, wherein advancing the sliding window is in response to:
sending the predetermined number of requests for the most recent active epoch; and
determining that outstanding responses have been received to all requests sent for the oldest active epoch.

18. A non-transitory computer-readable medium storing instructions which when executed by a processing resource cause the processing resource to perform a method, the method comprising:
generating, by a requester in a network fabric, a full initial value (IV) associated with encryption of roundtrip communications with a responder;
sending, by the requester to the responder, a request indicating a security value comprising:
a number of least significant bits (LSBs) of the full IV, and
two or more most significant bits (MSBs) of the security value identifying an epoch associated with a predetermined number of requests allowed to be sent by the requester to the responder;
identifying, by the requester, a sliding window associated with:
a plurality of active epochs corresponding to a time window in which the predetermined number of requests are currently allowed to be sent; and
at least one inactive epoch corresponding to a time window in which the predetermined number of requests are currently not allowed to be sent; and
sliding, by the requester, the window by setting an oldest active epoch to an inactive epoch and by setting a currently inactive epoch to an active epoch.

19. The non-transitory computer-readable medium of claim 18, the method further comprising:
encrypting the request based on a shared key and the full IV;
incrementing the full IV in response to sending the request;
receiving a response in response to sending the request to the responder; and
decrypting the response based on the shared key and the full IV used by the requester to encrypt the request,
wherein sliding the window is in response to:
sending the predetermined number of requests for the most recent active epoch; and
determining that outstanding responses have been received to all requests sent for the oldest active epoch.

20. The non-transitory computer-readable medium of claim 18, the method further comprising:
generating, by the responder, a partial IV based on most significant bits (MSBs) of the full IV;
receiving, by the responder, the request indicating the security value;
constructing, by the responder, the full IV based on the partial IV, the security value, and a plurality of previous partial IVs stored by the responder,
wherein constructing the full IV is further based on a current or a previous value of the partial IV, and
wherein constructing the full IV comprises incrementing the partial IV in response to determining no match between the received two or more MSBs of the security value and a possible set of matching epoch identifiers;
decrypting, by the responder, the request based on a shared key and the constructed full IV; and
sending, by the responder, to the requester in response to the request, a response encrypted based on the shared key and the constructed full IV, wherein the response omits the security value and the constructed full IV.
